(19) United States
(12) Patent Application Publication
(10) Pub. No.: US 2024/0421346 A1
(43) Pub. Date: Dec. 19, 2024

(54) SULFIDE-BASED SOLID ELECTROLYTE WITH ENHANCED INTERPARTICLE BINDING FORCE, SLURRY HAVING THE SAME, AND METHOD FOR PREPARING THE SAME

(71) Applicants: HYUNDAI MOTOR COMPANY, Seoul (KR); KIA CORPORATION, Seoul (KR); HANSOL CHEMICAL CO., LTD., Seoul (KR)

(72) Inventors: Sang Soo Lee, Goyang-si (KR); In Woo Song, Gwacheon-si (KR); Woo Dum Jung, Seoul (KR); So Young Kim, Jeongeup-si (KR); Sang Heon Lee, Yongin-si (KR); Hong Seok Min, Yongin-si (KR); Seul Ki Choi, Wanju-gun (KR); Chang Min Cho, Wanju-gun (KR); Woo Seop Song, Wanju-gun (KR); Young Sung Lee, Wanju-gun (KR); So Young Yoon, Wanju-gun (KR); Se Man Kwon, Wanju-gun (KR); Yung Sup Youn, Wanju-gun (KR)

(73) Assignees: Hyundai Motor Company, Seoul (KR); KIA CORPORATION, Seoul (KR); HANSOL CHEMICAL CO., LTD., Seoul (KR)

(21) Appl. No.: 18/402,468

(22) Filed: Jan. 2, 2024

(30) Foreign Application Priority Data
Jun. 16, 2023 (KR) 10-2023-0077590

(51) Int. Cl. H01M 10/0562

(52) U.S. Cl. CPC H01M 10/0562; H01M 2300/0068

(57) ABSTRACT

A sulfide-based solid electrolyte includes secondary particles in which primary particles are agglomerated. With the use of the sulfide-based solid electrolyte, a uniform, stable, and high-quality slurry in which the primary particles have a strong interparticle binding force can be prepared.

### CROSS REFERENCE TO RELATED APPLICATION

The present application claims the benefit of priority to Korean Patent Application No. 10-2023-0077590, filed on Jun. 16, 2023 in the Korean Intellectual Property Office, the entire contents of which is incorporated herein by reference.

### TECHNICAL FIELD

The present disclosure relates to a sulfide-based solid electrolyte including secondary particles formed by agglomeration of primary particles. With the use of the sulfide-based solid electrolyte, a uniform, stable, and high-quality slurry in which the primary particles have a strong interparticle binding force can be prepared.

### BACKGROUND

Today, secondary batteries are widely used in large devices such as automobiles and power storage systems and in small devices such as cell phones, camcorders, and laptops.

As the applications of rechargeable batteries expand, the need for improved safety and higher performance is increasing.

Compared to nickel-manganese batteries or nickel-cadmium batteries, lithium secondary batteries which are one type of secondary battery have the advantage of high energy density and large capacity per unit area.

The electrolytes used in conventional lithium secondary batteries are mostly liquid electrolytes, such as organic solvents. For this reason, safety issues such as electrolyte leakage and risk of ignition due to the leakage were a significant concern.

Recently, there has been a growing interest in all-solid-state batteries, which utilize solid electrolytes rather than liquid electrolytes to increase the safety of lithium secondary batteries.

Solid electrolytes are nonflammable or flame retardant. For this reason, solid-state electrodes are safer than liquid electrolytes.

There are two types of solid electrolytes: oxide-based solid electrolytes and sulfide-based solid electrolytes. Compared to oxide-based solid electrolytes, sulfide-based solid electrolytes have the advantage of high lithium-ion conductivity and stability over a wide voltage range.

Unlike oxide-based solid electrolytes, sulfide-based solid electrolytes have a problem in that heat treatment for crystallization cannot be performed at high temperatures because of elemental volatilization. Therefore, sulfide-based solid electrolytes suffer the problem of limited grain growth and contain a large number of fine primary particles. Weakly cohesive primary particles are easily broken down during cell manufacturing, leading to slurry instability.

The information disclosed in the Background section above is to aid in the understanding of the background of the present disclosure, and should not be taken as acknowledgement that this information forms any part of prior art.

### SUMMARY OF THE DISCLOSURE

Various aspects of the present disclosure are directed to providing a sulfide-based solid electrolyte made from highly cohesive primary particles and a method of preparing the same.

The objectives of the present disclosure are not limited to the objective described above. The above and other objectives of the present disclosure will become more apparent from the following description and will be realized by means recited in the claims and combinations of the means.

A sulfide-based solid electrolyte according to one exemplary embodiment of the present disclosure may include secondary particles formed by agglomeration of primary particles.

The sulfide-based solid electrolyte may have a primary interparticle binding force ε of 0.3 min·W·μm/mg or more.

The sulfide-based solid electrolyte may have a strain Δ∂ of 55 μm⁻¹ or less, the strain being expressed by Equation 1 below.

$$Δ \partial = {\sum }_{i = 0.001 μ m}^{1 μ m} ( \frac{vol \% of {i}_{after )}}{particle size {i}_{after}} ) - {\sum }_{i = 0.001 μ m}^{1 μ m} ( \frac{vol \% of {i}_{before )}}{particle size {i}_{before}} ) \qquad [ Equation 1 ]$$

Here, the particle size i_{before} may represent a median diameter D50.

The vol % of i_{before} may represent a volume percentage of particles with a median diameter D50 of i μm before ultrasonic treatment.

The particle size i_{after} may represent a median diameter D50.

The vol % of i_{before} may represent a volume percentage of particles with a median diameter D50 of i μm before ultrasonic treatment.

The sulfide-based solid electrolyte may have an initial differential weight ∂_{before} of 40 μm⁻¹ or less, represented by Equation 2 below.

$${\partial }_{before} = {\sum }_{i = 0.001 μ m}^{1 μ m} ( \frac{vol \% of {i}_{before )}}{particle size {i}_{before}} ) \qquad [ Equation 2 ]$$

Here, the particle size i_{before} may represent a median diameter D50.

The vol % of i_{before} may represent a volume percentage of particles with a median diameter D50 of i μm before ultrasonic treatment.

A slurry according to one exemplary embodiment of the present disclosure may include a sulfide-based solid electrolyte and a dispersion medium.

The slurry may have an initial viscosity μ₀ of 5,000 cp or less.

The slurry may have a secular change in viscosity of 10% or less, as represented by Equation 3 below.

$$\frac{( {μ}_{48 h} - {μ}_{0} )}{{μ}_{0}} \times 100 \qquad [ Equation 3 ]$$

Here, the μ₀ may represent an initial viscosity.

The μ₄₈ₕ may represent a viscosity measured after 48 hours of storage after measuring the initial viscosity.

A method of preparing a sulfide-based solid electrolyte, according to one exemplary embodiment of the present disclosure, may include: preparing a raw material; obtaining a precursor by reacting the raw material; and obtaining the sulfide-based solid electrolyte by heat treating the precursor.

In the obtaining of the precursor, the precursor may be obtained by agitating the raw material to prompt reaction and maintaining the raw material in a temperature range of 0° C. to 30° C.

The obtaining of the sulfide-based solid electrolyte may be performed by heat treating the precursor at temperature in a range of 400° C. to 550° C.

According to the present disclosure, a sulfide-based solid electrolyte with a high primary interparticle bonding force can be obtained, and a method of preparing the same electrolyte can be obtained.

According to the present disclosure, a stable slurry in which the sulfide-based solid electrolyte is uniformly dispersed can be obtained.

The effect and advantages of the present disclosure are not limited to the ones described above. The effects and advantages of the present disclosure are to be understood to include all effects and advantages that can be inferred from the following description.

### BRIEF DESCRIPTION OF THE DRAWINGS

FIG. 1 shows an all-solid-state battery according to one exemplary embodiment of the present disclosure;

FIG. 2 shows a scanning electron microscopy (SEM) image of a precursor according to one preparation example of the present disclosure;

FIG. 3 shows an SEM image of a precursor according to a comparative preparation example;

FIG. 4 shows an SEM image of a sulfide-based solid electrolyte according to Example 1;

FIG. 5 shows an SEM image of a sulfide-based solid electrolyte according to Example 2;

FIG. 6 shows an SEM image of a sulfide-based solid electrolyte according to Example 3;

FIG. 7 shows an SEM image of a sulfide-based solid electrolyte according to Comparative Example 1;

FIG. 8 shows an SEM image of a sulfide-based solid electrolyte according to Comparative Example 2;

FIG. 9 shows the results of analysis of the particle size distribution of the sulfide-based solid electrolyte according to Example 1, in which the analysis is performed before and after treatment with an ultrasonic pulverizer;

FIG. 10 shows the results of analysis of the particle size distribution of the sulfide-based solid electrolyte according to Example 2, in which the analysis is performed before and after treatment with an ultrasonic pulverizer;

FIG. 11 shows the results of analysis of the particle size distribution of the sulfide-based solid electrolyte according to Example 3, in which the analysis is performed before and after treatment with an ultrasonic pulverizer;

FIG. 12 shows the results of analysis of the particle size distribution of the sulfide-based solid electrolyte according to Comparative Example 1, in which the analysis is performed before and after treatment with an ultrasonic pulverizer;

FIG. 13 shows the results of analysis of the particle size distribution of the sulfide-based solid electrolyte according to Comparative Example 2, in which the analysis is performed before and after treatment with an ultrasonic pulverizer;

FIG. 14 shows the results of stability analysis of a slurry containing the sulfide-based solid electrolyte according to Example 1, the analysis being performed with a dispersion stabilizer (Turbiscan);

FIG. 15 shows an enlarged view illustrating a 4 to 36-mm zone of FIG. 14 in an enlarged manner;

FIG. 16 shows the results of stability analysis of a slurry containing the sulfide-based solid electrolyte according to Example 2, the analysis being performed with a dispersion stabilizer;

FIG. 17 shows an enlarged view illustrating a 4 to 36-mm zone of FIG. 16 in an enlarged manner;

FIG. 18 shows the results of observation of the surface of a film formed by applying a slurry containing the sulfide-based solid electrolyte according to Comparative Example 1 to a substrate; and

FIG. 19 shows the results of observation of the surface of a film formed by applying a slurry containing the sulfide-based solid electrolyte according to Example 2 to a substrate.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Above objectives, other objectives, features, and advantages of the present disclosure will be readily understood from the following exemplary embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art.

Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise.

It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value to the maximum value of the range, unless otherwise indicated. Moreover, when such a range pertains to integer values, all integers including the minimum value to the maximum value are included, unless otherwise indicated.

FIG. 1 shows an all-solid-state battery according to one exemplary embodiment of the present disclosure. An all-solid-state battery may include a cathode 10, an anode 20, and a solid electrolyte layer 30 interposed between the cathode 10 and the anode 20. At least one of the cathode 10, the anode 20, and the solid electrolyte layer 30 may include the sulfide-based solid electrolyte according to one exemplary embodiment of the present disclosure.

The sulfide-based solid electrolyte may be a compound including (Li), elemental phosphorus (P), elemental sulfur(S), and the like. For example, the sulfide-based solid electrolyte may include Li₃PS₄.

However, the composition of the sulfide-based solid electrolyte is not limited thereto. The sulfide-based solid electrolyte may include a compound represented by Formula 1 shown below, or a compound represented by Formula 2 shown below.

Li₇-aPS₆-aXₐ [Formula 1]

Here, a satisfies a condition of 1≤a≤2.

Here, X represents a halogen element.

Li₇-aPS₆-a(X1_{b}X2_{1-b})ₐ [Formula 2]

Here, a satisfies a condition of 1≤a≤2.

Here, b satisfies a condition of 0<b<1.

X1 and X2 may be different halogen elements.

The sulfide-based solid electrolyte may further include one element selected from the group consisting of boron (B), carbon (C), nitrogen (N), aluminum (Al), silicon (Si), vanadium (V), manganese (Mn), iron (Fe), cobalt (Co), nickel (Ni), copper (Cu), zinc (Zn), gallium (Ga), germanium (Ge), arsenic (As), silver (Ag), cadmium (Cd), tin (Sn), antimony (Sb), tellurium (Te), lead (Pb), bismuth (Bi), and combinations thereof. The selected element may be included instead of phosphorus (P) or sulfur(S).

The sulfide-based solid electrolyte may have an azirodite-type crystal structure.

The sulfide-based solid electrolyte may include secondary particles formed by agglomeration of primary particles. The sulfide-based solid electrolyte according to one exemplary embodiment of the present disclosure has a high primary interparticle binding force, so that particle growth is adequate and may not disintegrate when contained in a slurry phase. The primary interparticle binding force can be increased by adjusting the raw material reaction conditions or heat treatment conditions in the process of preparing the sulfide-based solid electrolyte.

A method of preparing a sulfide-based solid electrolyte, according to one exemplary embodiment of the present disclosure, may include the steps of: preparing raw materials, obtaining a precursor by reacting the raw materials, and obtaining a sulfide-based solid electrolyte by heat treating the precursor.

The raw materials may be prepared by weighing appropriate amounts of the required materials according to the composition of the desired sulfide-based solid electrolyte. For example, the raw materials may include a lithium source, a sulfide source, a halogen source, and the like.

Examples of the lithium source may include Li₂S, a lithium simple substance, and the like.

Examples of the sulfide source may include P₂S₃, P₂S₅, P₄S₃, P₄S₅, P₄S₇, P₄S₁₀, a sulfur simple substance, and the like.

Examples of the halogen source may include LiX (X═F, Cl, Br, or I) and a halogen simple substance.

As used herein, the term “simple substance” refers to a substance composed of a single element and exhibiting unique chemical properties. Thus, the lithium single substance means a substance composed solely of the element lithium and exhibiting unique chemical properties, and the sulfur simple substance means a substance composed solely of the element sulfur and exhibiting unique chemical properties.

The raw materials prepared as described above are added to a solvent and are stirred to cause a reaction. As a result, a precursor can be obtained.

The solvent is not particularly limited, but any solvent capable of dissolving the raw materials can be used without limitation. For example, the solvent may include at least one selected from the group consisting of methanol, ethanol, propanol, butanol, carbonate, dimethyl ethyl acetate, tetrahydrofuran, 1,2-dimethoxyethane, propylene glycol dimethyl ether, acetonitrile, and combinations thereof.

When the raw materials are introduced into the solvent and then stirred, the raw materials are dissolved in the solvent, and a reaction occurs between the raw materials to produce a precursor. The stirring conditions are not particularly limited, and the stirring is performed under conditions of a predetermined stirring speed and a reaction time that allow the raw materials to sufficiently dissolve and react with each other in the solvent.

However, it is necessary to control the temperature of the raw materials during the reaction because the natural increase in temperature due to the heat of reaction of the raw materials excessively accelerates the formation rate of primary particles, resulting in uneven particles. Specifically, the present disclosure is characterized in that the precursor is obtained by reacting the raw materials under stirring, while maintaining the temperature of the raw materials to be in a range of 0° C. and 30° C. When the temperature of the raw materials exceeds 30° C., the primary particles may form at an excessively high rate and their size may be uneven. When the temperature of the raw materials is below 0° C., the reaction between the raw materials may not properly occur.

The method of maintaining the temperature of the raw materials is not particularly limited. For example, the temperature of the raw materials can be maintained in a manner that the reaction is performed with the reactor containing the raw materials placed in a bath.

The method may further include the step of drying the precursor. The step of drying is performed to remove the solvent.

The step of drying may be performed under conditions in which the precursor does not deteriorate. For example, the precursor may be vacuum dried at temperature in a range of 25° C. to 200° C. for a duration in a range of 2 hours to 20 hours. According to one exemplary embodiment of the present disclosure, vacuum drying is performed to prevent the precursor from reacting with external moisture or the like.

The precursor may then be heat treated to obtain a crystalline sulfide-based solid electrolyte. The sulfide-based solid electrolyte may include secondary particles formed by agglomeration of the primary particles formed by the reaction described above. The heat treatment may be performed at temperature in a range of 400° C. to 550° C. for a duration in a range of 1 hour to 10 hours. When the temperature of the heat treatment is in the mentioned range, the interparticle binding force of the primary particles is increased, which can prevent the sulfide-based solid electrolyte from being disintegrated during slurry preparation.

The method may further include the step of grinding the sulfide-based solid electrolyte obtained as described above to a desired particle size.

The sulfide-based solid electrolyte obtained as described above, alone or in combination with other components such as an active material, a binder, a conductor, and the like, is introduced into a dispersion medium to prepare a slurry. The slurry may be applied to a substrate to form the cathode 10, the anode 20, and/or the solid electrolyte layer 30.

The dispersion medium is not particularly limited. Any material that is capable of dispersing the sulfide-based solid electrolyte, the active material, and the like well without reacting therewith will be use as the dispersion medium. For example, the dispersion medium may include at least one selected from the group consisting of toluene, heptane, N-methyl-2-pyrrolidone (NMP), acetone, N, N-dimethylformamide (DMF), and combinations thereof.

Other forms of the disclosure will be described in more detail, through the following examples. The following examples are presented only to aid in understanding of the present disclosure and are not intended to limit the scope of the disclosure.

### Preparation Example

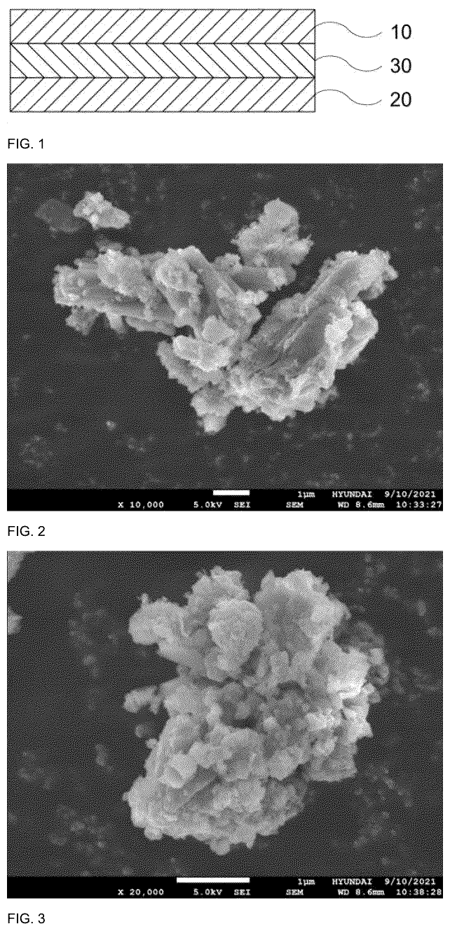

Raw materials including Li₂S, P₂S₅, and LiCl were prepared to satisfy the composition of Li₆PS₅Cl. The raw materials were added to a solvent and stirred to cause a reaction, thereby producing a precursor. The temperature of the raw materials was controlled using a cooling device so that the temperature of the raw materials was in the range of 0° C. and 30° C. during the reaction. FIG. 2 shows a scanning electron microscopy (SEM) image of the precursor prepared according to the preparation example.

### Comparative Preparation Example

A precursor was prepared with the same raw materials and method as in the above example, except that the temperature of the raw materials was not controlled during the reaction. In the reaction of the comparative preparation example, the temperature of the raw materials was about 30° C. to 50° C. FIG. 3 shows an SEM image of the precursor according to the comparative preparation example.

Referring to FIG. 3, in the precursor according to the comparative preparation example, a large number of extremely fine primary particles with sizes of tens to hundreds of nanometers exist. On the other hand, referring to FIG. 2, it can be seen that the precursor according to the preparation example has primary particles with a relatively large size. The fine primary particles with sizes of tens to hundreds of nanometers is present in a relatively small amount. When preparing the precursor, the temperature rises due to the exothermic reaction of the raw materials and the growth of particles begins. In this case, excessive reaction heat can cause rapid and uneven particle growth. Therefore, the present disclosure prevents the rapid and uneven growth of primary particles by keeping the temperature of the raw materials low during the reaction.

### Example 1

A sulfide-based solid electrolyte was prepared by heat treating the precursor prepared according to the preparation example to about 430° C.

### Example 2

A sulfide-based solid electrolyte was prepared by heat treating the precursor prepared according to the preparation example to about 500° C.

### Example 3

A sulfide-based solid electrolyte was prepared by heat treating the precursor prepared according to the preparation example to about 550° C.

### Comparative Example 1

A sulfide-based solid electrolyte was prepared by heat treating the precursor prepared according to the comparative preparation example to about 430° C.

### Comparative Example 2

A sulfide-based solid electrolyte was prepared by heat treating the precursor prepared according to the comparative preparation example to about 500° C.

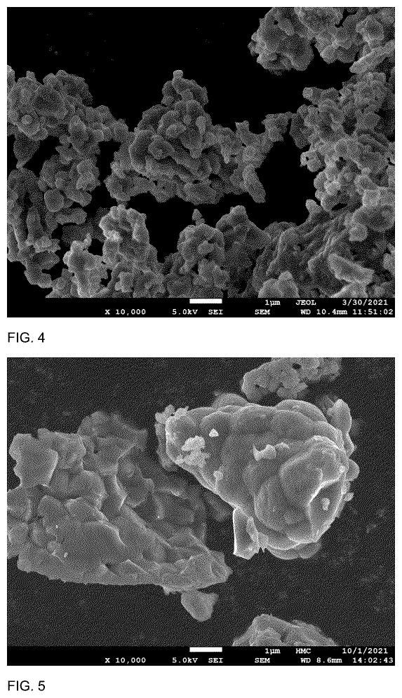

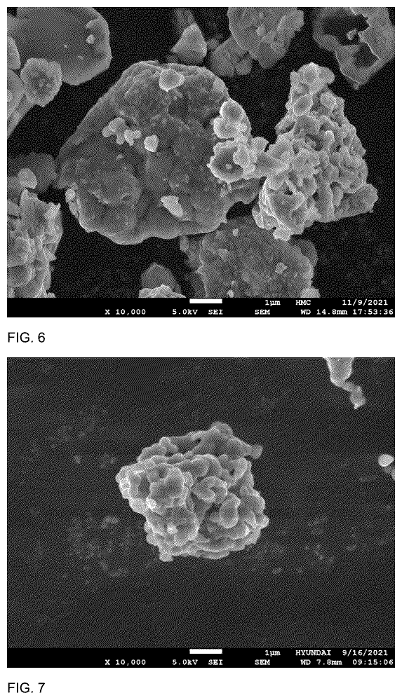

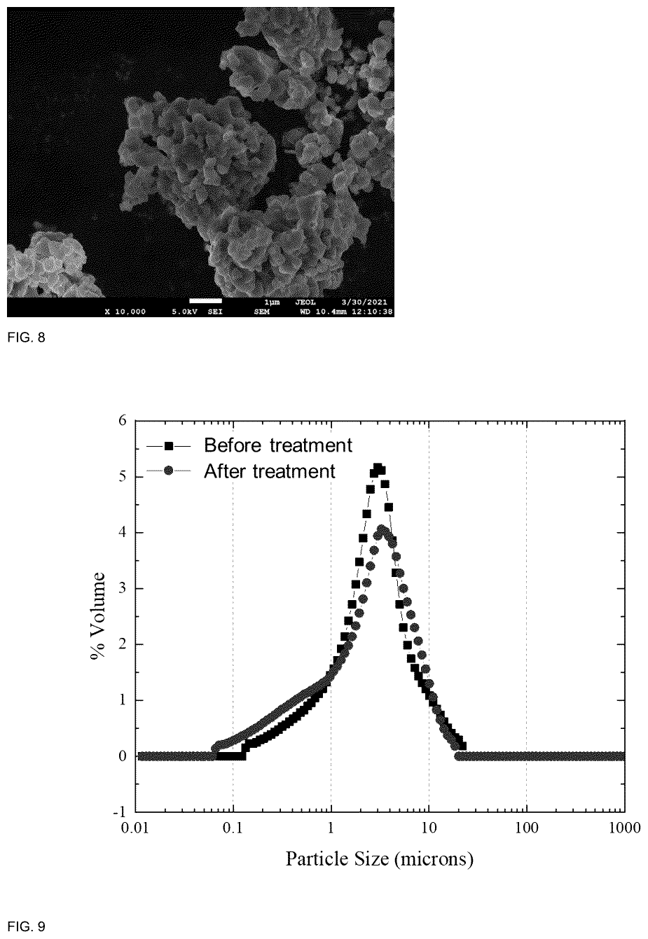

FIG. 4 shows an SEM image of the sulfide-based solid electrolyte according to Example 1. FIG. 5 shows an SEM image of a sulfide-based solid electrolyte according to Example 2. FIG. 6 shows an SEM image of a sulfide-based solid electrolyte according to Example 3. FIG. 7 shows an SEM image of a sulfide-based solid electrolyte according to Comparative Example 1. FIG. 8 shows an SEM image of a sulfide-based solid electrolyte according to Comparative Example 2.

Referring to FIG. 7, the sulfide-based solid electrolytes according to the comparative examples have secondary particles in which the primary particles of tens to hundreds of nanometers are weakly agglomerated. This is evidenced by a large number of gaps between the primary particles and a large number of voids within each of the secondary particles.

Referring to FIGS. 4 to 6, the sulfide-based solid electrolyte according to any of Examples 1 to 3 has a high primary interparticle binding force, as evidenced by the small gaps between the primary particles and the absence of voids the secondary particles.

The strain (Aa) of each of the sulfide-based solid electrolytes according to Examples 1 to 3 and Comparative Examples 1 to 2 and the interparticle binding force ε of the primary particles were evaluated by particle size distribution (PSD) analysis. Specifically, the particle size distribution of each sulfide-based solid electrolyte was measured before and after treatment with a probe-type ultrasonic pulverizer. The power of the probe was about 200 W, and a small amount of sulfide-based solid electrolyte was treated intensively for about 60 seconds.

The strain Δ∂ of a sulfide-based solid electrolyte may be a change in the differential weight a before and after treatment with an ultrasonic pulverizer. The differential weight a is a value obtained by dividing a volume percentage of particles with predetermined particle sizes by a median diameter D50 of the particles. The differential indicates changes in influence of the particle size. The differential weight a may indicate a tendency in which the degree of influence of the particle size on the quality of the slurry or film increase as the size of the particles is decreased. The strain Δ∂ can be expressed by the following equation.

$$Δ \partial = {\sum }_{i = 0.001 μ m}^{1 μ m} ( \frac{vol \% of {i}_{after )}}{particle size {i}_{after}} ) - {\sum }_{i = 0.001 μ m}^{1 μ m} ( \frac{vol \% of {i}_{before )}}{particle size {i}_{before}} )$$

The particle size before represents a median diameter D50 of the particles, and the vol % of i_{before} represents a volume percentage of the particles with a median diameter D50 of i μm before ultrasonic treatment.

The particle size i_{after} represents a median diameter D50 of the particles, and the vol % of i_{after} represents a volume percentage of the particles with a median diameter D50 of i μm after ultrasonic treatment.

In the equation, the overall weight can be set by integrating the sub micrometer values (i.e., less than or equal to 1 μm) having a dominant influence on the quality of the slurry or film.

The initial differential weight ∂before may represent the weight of the initial influence of the particles before the particles are processed with the ultrasonic pulverizer. The initial differential weight before can be expressed by the following equation.

$${\partial }_{before} = {\sum }_{i = 0.001 μ m}^{1 μ m} ( \frac{vol \% of {i}_{before )}}{particle size {i}_{before}} )$$

The particle size i_{before} represents a median diameter D50 of the particles, and the vol % of i_{before} represents a volume percentage of the particles with a median diameter D50 of i μm before ultrasonic treatment.

The interparticle binding force ε of the primary particles is a primary interparticle factor of the primary particles forming the secondary particles and can reflect the relative energy applied to the sulfide-based solid electrolyte by the treatment with an ultrasonic pulverizer. The interparticle binding force ε of the primary particles can be expressed by the following equation.

$$ε = \frac{t \cdot p}{Δ \partial \cdot w}$$

Here, t represents the processing time of the treatment with an ultrasonic pulverizer. Here, p represents the power of a probe. W represents the weight of the sulfide-based solid electrolyte treated with an ultrasonic pulverizer. Δ∂ represents the strain of the sulfide-based solid electrolyte.

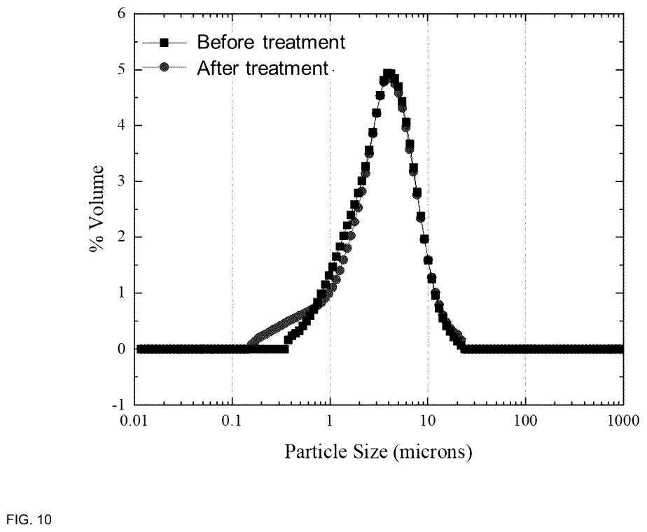

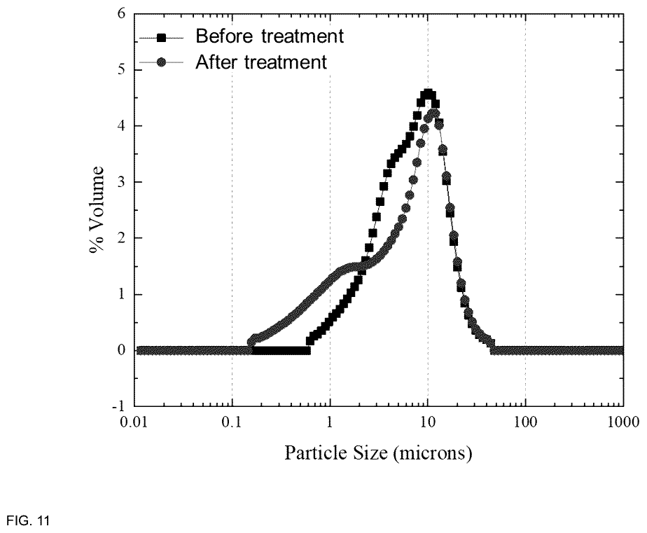

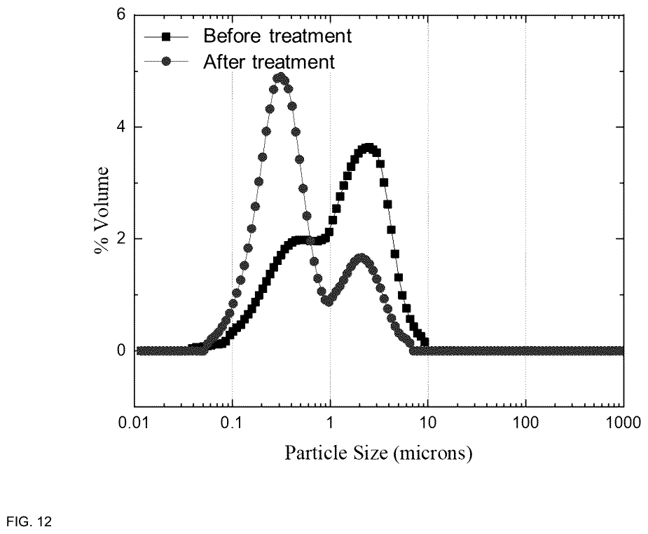

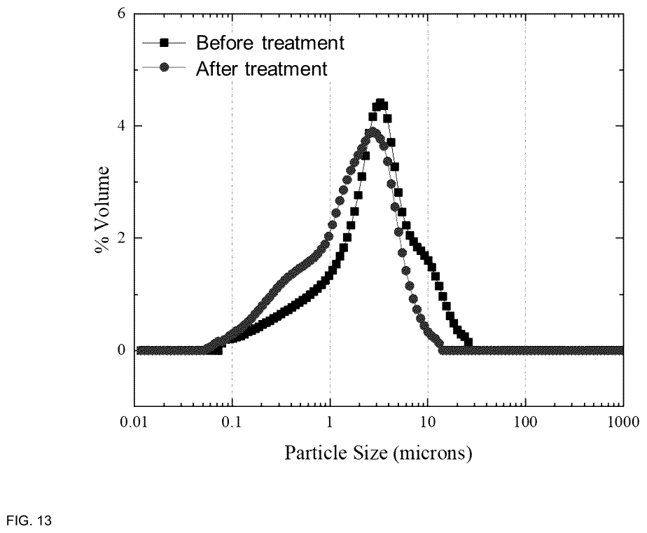

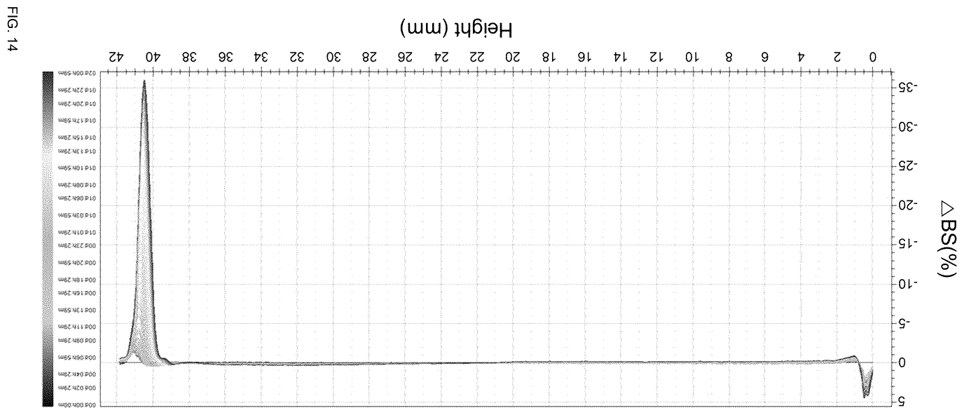

FIG. 9 shows the results of analysis of the particle size distribution of the sulfide-based solid electrolyte according to Example 1, in which the analysis is performed before and after treatment with an ultrasonic pulverizer. FIG. 10 shows the results of analysis of the particle size distribution of the sulfide-based solid electrolyte according to Example 2, in which the analysis is performed before and after treatment with an ultrasonic pulverizer. FIG. 11 shows the results of analysis of the particle size distribution of the sulfide-based solid electrolyte according to Example 3, in which the analysis is performed before and after treatment with an ultrasonic pulverizer. FIG. 12 shows the results of analysis of the particle size distribution of the sulfide-based solid electrolyte according to Comparative Example 1, in which the analysis is performed before and after treatment with an ultrasonic pulverizer. FIG. 13 shows the results of analysis of the particle size distribution of the sulfide-based solid electrolyte according to Comparative Example 2, in which the analysis is performed before and after treatment with an ultrasonic pulverizer. Based on the results of FIGS. 9 to 13, the strain Δ∂, the initial differential weight ∂before, and the interparticle binding force ε of the primary particles of each sulfide-based solid electrolyte are calculated and shown in Table 1 below.

TABLE 1

| Classification | ∂_{before} | ∂_{after} | Δ∂ | ε |
|---|---|---|---|---|
| Comparative | 133.150 | 305.326 | 172.175 | 0.116 |
| Example 1 | | | | |
| Comparative | 58.032 | 99.467 | 41.435 | 0.483 |
| Example 2 | | | | |
| Example 1 | 37.247 | 79.188 | 41.941 | 0.477 |
| Example 2 | 10.921 | 25.040 | 14.119 | 1.417 |
| Example 3 | 2.469 | 29.615 | 52.413 | 0.737 |

Referring to Table 1, in the sulfide-based solid electrolyte according to one exemplary embodiment of the present disclosure, the interparticle binding force ε of the primary particles is greater than or equal to 0.3 min·W·μm/mg. The upper limit of the interparticle binding force ε of the primary particles is not particularly limited. It may be less than or equal to 2 min·W·μm/mg.

The sulfide-based solid electrolyte according to one exemplary embodiment of the present disclosure has a strain Δ∂ of 55 μm⁻¹ or less. The lower limit of the strain Δ∂ is not particularly limited. For example, it is greater than or equal to 10 μm⁻¹.

The initial differential weight ∂before of the sulfide-based solid electrolyte according to one exemplary embodiment of the present disclosure is less than or equal to 40 μm⁻¹. The lower limit of the initial differential weight ∂before is not particularly limited. For example, it is greater than or equal to 1 μm⁻¹.

Referring to Table 1, the sulfide-based solid electrolyte according to Comparative Example 1 has the lowest interparticle binding force ε of the primary particles, and the sulfide-based solid electrolyte according to Example 2 has the highest interparticle binding force ε of the primary particles. Furthermore, in the case of Comparative Example 2, the interparticle binding force ε of the primary particles is relatively strong, but the initial differential weight ∂before is relatively low compared to Examples. Therefore, when a slurry is prepared from the electrolyte of Comparative Example 2, the slurry has a high initial viscosity and a high secular change in viscosity, thereby forming a film with low quality.

Slurries were prepared by dispersing each of the sulfide-based solid electrolytes according to Examples 1 to 3 and Comparative Examples 1 and 2 in a dispersion medium. The initial viscosity of each slurry was measured, and the secular change in viscosity of each slurry was calculated by measuring the viscosity of each slurry after 48 hours of storage after the measurement of the initial viscosity. The results are shown in Table 2 below.

TABLE 2

| | | Viscosity | |
|---|---|---|---|
| | Initial | after 48 hours | Secular |
| Classification | viscosity [cp] | [cp] | change [%] |
| Comparative | 6,240 | 7,340 | 17.63 |
| Example 1 | | | |
| Comparative | 6,560 | 7,520 | 14.6 |
| Example 2 | | | |
| Example 1 | 4,760 | 5,100 | 7.1 |
| Example 2 | 4,580 | 4,640 | 1.3 |
| Example 3 | 4,380 | 4,560 | 4.1 |

Referring to Table 2, a slurry containing the sulfide-based solid electrolyte according to one exemplary embodiment of the present disclosure has an initial viscosity μ₀ of 5,000 cp or less. Herein, the initial viscosity μ₀ may refer to the viscosity measured at timing at which the sulfide-based solid electrolyte is added to the dispersion medium, and the sulfide-based solid electrolyte is uniformly dispersed in the dispersion medium by stirring for a sufficient time. The lower limit of the initial viscosity μ₀ is not particularly limited. For example, the lower limit is greater than or equal to 3,000 cp.

Furthermore, the slurry containing the sulfide-based solid electrolyte according to one exemplary embodiment of the present disclosure has a secular change in viscosity of 10% or less, expressed by the following equation. The lower limit of the secular change is not particularly limited. For example, the lower limit is greater than or equal to 1%.

$$\frac{( {μ}_{48 h} - {μ}_{0} )}{{μ}_{0}} \times 100$$

μ₄₈ₕ represents an initial viscosity, and μ₄₈ₕ represents a viscosity measured after 48 hours of storage after measuring the initial viscosity.

Referring to Table 2, the slurries containing the respective sulfide-based solid electrolytes according to Example 1 and Example 2 are highly unstable because they have a high initial viscosity and a high secular change in viscosity. On the other hand, it is seen that the slurry of Example 2 is considerably stable, with about a 1% secular change in viscosity.

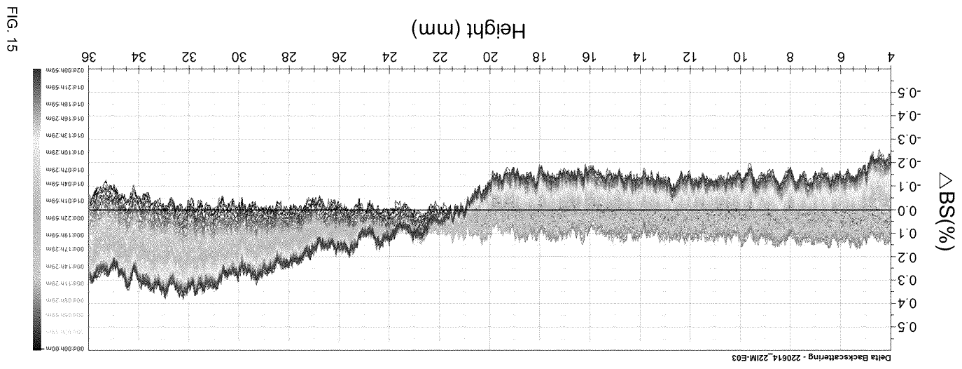

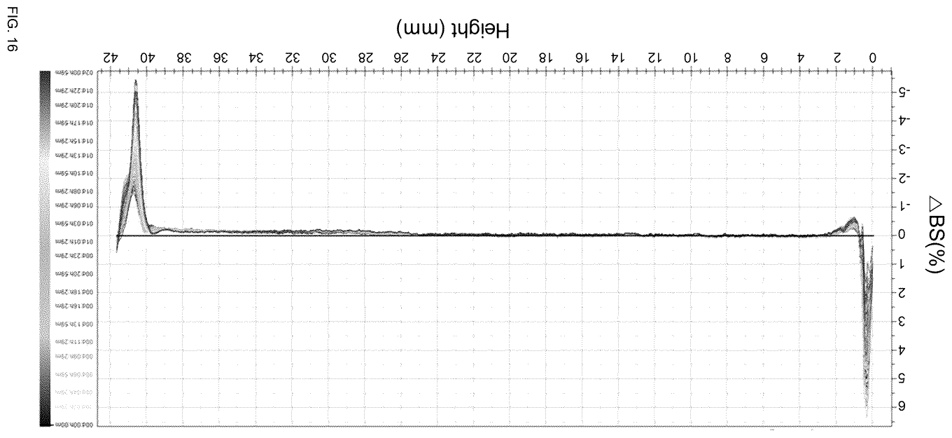

FIG. 14 shows the results of stability analysis of a slurry containing the sulfide-based solid electrolyte according to Example 1, the analysis being performed with a dispersion stabilizer (Turbiscan). FIG. 15 shows an enlarged view illustrating a 4 to 36-mm zone of FIG. 14 in an enlarged manner.

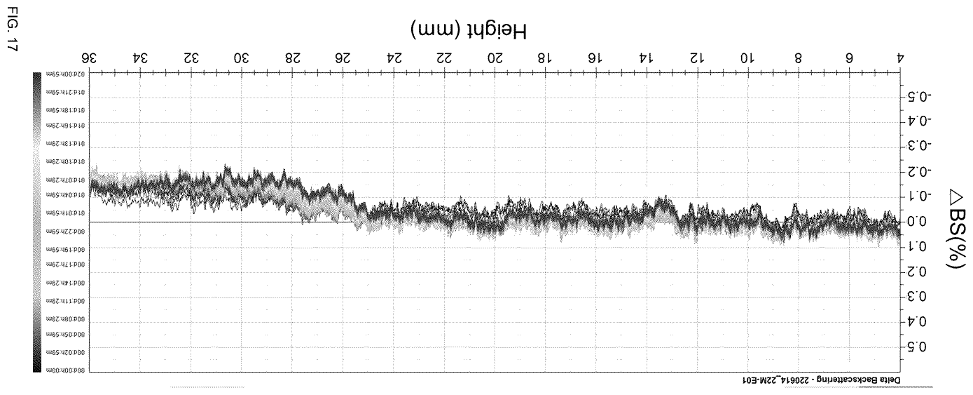

FIG. 16 shows the results of stability analysis of a slurry containing the sulfide-based solid electrolyte according to Example 2, the analysis being performed with a dispersion stabilizer. FIG. 17 shows an enlarged view illustrating a 4 to 36-mm zone of FIG. 16 in an enlarged manner.

The dispersion stabilizer (Turbiscan) is an optical analyzer that analyzes the physical and chemical properties of a sample using the intensity of light transmitted after being emitted from a light source and the intensity of the scattered light. Each slurry was injected into a 70 mm tall cylindrical glass vial up to a height of approximately 42 mm and allowed to stand for approximately 48 hours before being mounted on the dispersion stabilizer (Turbiscan). The light source was operated to irradiate the glass vial with light of near-infrared wavelengths (λ=880 nm) at intervals of about 40 μm along the height direction of the glass vial. The intensity of transmitted and scattered light was measured with a transmittance meter located opposite the light source and a backscatter meter located at an angle of 45° to the light source.

Referring to FIG. 14, the slurry containing the sulfide-based solid electrolyte according to Comparative Example 1 experiences significant flocculation and settling of the particles in an upper portion of the vial, over time. Furthermore, in light of the non-symmetry of the change values at the top near 40 mm height and the bottom near 0 mm height, the slurry is anticipated to exhibit non-ideal, unpredictable changes. Referring to FIG. 15, the slurry in the middle region shows large changes and forms a double layer, meaning that the slurry is highly unstable.

Referring to FIG. 16, the slurry containing the sulfide-based solid electrolyte according to Example 2 shows a reduction of about 85% in the flocculation and setting of the particles compared to the slurry containing the sulfide-based solid electrolyte according to Comparative Example 1. Furthermore, unlike Comparative Example 1, the slurry is expected to exhibit simple, predictable changes, in light of the symmetry of the change values at the top near 40 mm and the bottom near 0 mm. Referring to FIG. 17, it can be seen that the slurry is extremely stable with relatively low changes in the middle region compared to FIG. 15.

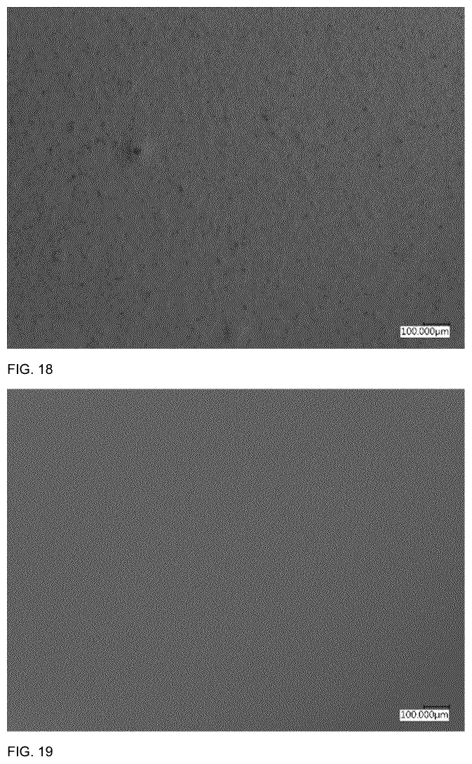

FIG. 18 shows the results of observation of the surface of a film formed by applying a slurry containing the sulfide-based solid electrolyte according to Comparative Example 1 to a substrate. FIG. 19 shows the results of observation of the surface of a film formed by applying a slurry containing the sulfide-based solid electrolyte according to Example 2 to a substrate.

Referring to FIGS. 18 and 19, the surface of each film made of the slurry containing the sulfide-based solid electrolyte according to Example 2 has a uniform appearance quality without any unevenness, pinholes, and the like in the surface.

Although examples and experimental examples according to various exemplary embodiments of the present disclosure have been described for illustrative purposes, those skilled in the art will appreciate that various modifications, additions and substitutions are possible, without departing from the scope and spirit of the invention as defined by the appended claims,

What is claimed is:

1. A sulfide-based solid electrolyte comprising:
secondary particles in which primary particles are agglomerated,
wherein interparticle binding force ε of the primary particles is greater than or equal to 0.3 min·W·μm/mg.

2. The sulfide-based solid electrolyte of claim 1, wherein a strain Δ∂ represented by Equation 1 below is less than or equal to 55 μm⁻¹,
$$Δ \partial = {\sum }_{i = 0.001 μ m}^{1 μ m} ( \frac{vol \% of {i}_{after )}}{particle size {i}_{after}} ) - {\sum }_{i = 0.001 μ m}^{1 μ m} ( \frac{vol \% of {i}_{before )}}{particle size {i}_{before}} ) \qquad [ Equation 1 ]$$
wherein particle size before represents a median diameter D50,
vol % of i_{before} represents a volume percentage of particles with a median diameter D50 of i μm before ultrasonic treatment, and
particle size i_{after} represents a median diameter D50, and
vol % of i_{after} represents a volume percentage of particles with a median diameter D50 of i μm after the ultrasonic treatment.

3. The sulfide-based solid electrolyte of claim 1, wherein an initial differential weight ∂_{before} is less than or equal to 40 μm⁻¹,
$${\partial }_{before} = {\sum }_{i = 0.001 μ m}^{1 μ m} ( \frac{vol \% of {i}_{before )}}{particle size {i}_{before}} ) \qquad [ Equation 2 ]$$
wherein particle size i_{before} represents a median diameter D50, and
vol % of i_{before} represents a volume percentage of particles with a median diameter D50 of i μm before the ultrasonic treatment.

4. A slurry comprising a sulfide-based solid electrolyte and a dispersion medium,
wherein the sulfide-based solid electrolyte comprises secondary particles in which primary particles are agglomerated, and
interparticle binding force of the primary particles is greater than or equal to 0.3 min·W·μm/mg.

5. The slurry of claim 4, wherein a strain Δ∂ represented by Equation 1 below is less than or equal to 55 μm⁻¹,
$$Δ \partial = {\sum }_{i = 0.001 μ m}^{1 μ m} ( \frac{vol \% of {i}_{after )}}{particle size {i}_{after}} ) - {\sum }_{i = 0.001 μ m}^{1 μ m} ( \frac{vol \% of {i}_{before )}}{particle size {i}_{before}} ) \qquad [ Equation 1 ]$$
wherein particle size i_{before} represents a median diameter D50, and
vol % of i_{before} represents a volume percentage of particles with a median diameter D50 of i μm before ultrasonic treatment,
particle size i_{after} represents a median diameter D50, and
the vol % of i_{after} represents a volume percentage of particles with a median diameter D50 of i μm after the ultrasonic treatment.

6. The slurry of claim 4, wherein an initial differential weight ∂_{before} is less than or equal to 40 μm⁻¹,
$${\partial }_{before} = {\sum }_{i = 0.001 μ m}^{1 μ m} ( \frac{vol \% of {i}_{before )}}{particle size {i}_{before}} ) \qquad [ Equation 2 ]$$
wherein particle size i_{before} represents a median diameter D50, and
vol % of i_{before} represents a volume percentage of particles with a median diameter D50 of i μm before the ultrasonic treatment.

7. The slurry of claim 4, wherein the slurry has an initial viscosity μ₀ of 5,000 cp or less.

8. The slurry of claim 4, wherein the slurry has a secular change in viscosity of 10% or less, expressed by Equation 3 below,
$$\frac{( {μ}_{48 h} - {μ}_{0} )}{{μ}_{0}} \times 100 \qquad [ Equation 3 ]$$
wherein μ₀ represents an initial viscosity, and
μ₄₈ₕ represents a viscosity measured after 48 hours of storage after measuring the initial viscosity.

9. A method of preparing a sulfide-based solid electrolyte, the method comprising:
preparing a raw material;
obtaining a precursor by causing a reaction of the raw material; and
obtaining the sulfide-based solid electrolyte by heat treating the precursor,
wherein the sulfide-based solid electrolyte comprises secondary particles in which primary particles are agglomerated, and
interparticle binding force of the primary particles is greater than or equal to 0.3 min·W·μm/mg.

10. The method of claim 9, wherein in the obtaining of the precursor, the raw material is reacted under stirring while the temperature of the raw material is maintained in a range of 0° C. to 30° C.

11. The method of claim 9, wherein in the obtaining the sulfide-based solid electrolyte, the precursor is heat treated at temperature in a range of 400° C. to 550° C.

12. The method of claim 9, wherein the sulfide-based solid electrolyte has a strain Δ∂ of 55 μm⁻¹ or less, represented by Equation 1 below.
$$Δ \partial = {\sum }_{i = 0.001 μ m}^{1 μ m} ( \frac{vol \% of {i}_{after )}}{particle size {i}_{after}} ) - {\sum }_{i = 0.001 μ m}^{1 μ m} ( \frac{vol \% of {i}_{before )}}{particle size {i}_{before}} ) \qquad [ Equation 1 ]$$
wherein particle size i_{before} represents a median diameter D50, and
vol % of i_{before} represents a volume percentage of particles with a median diameter D50 of i μm before ultrasonic treatment,
particle size i_{after} represents a median diameter D50, and
vol % of i_{after} represents a volume percentage of particles with a median diameter D50 of i μm after the ultrasonic treatment.

13. The method of claim 9, wherein the sulfide-based solid electrolyte has an initial differential weight ∂_{before} of 40 μm⁻¹ or less, represented by Equation 2 below,
$${\partial }_{before} = {\sum }_{i = 0.001 μ m}^{1 μ m} ( \frac{vol \% of {i}_{before )}}{particle size {i}_{before}} ) \qquad [ Equation 2 ]$$
wherein particle size i_{before} represents a median diameter D50, and
vol % of i_{before} represents a volume percentage of particles with a median diameter D50 of i μm before the ultrasonic treatment.
